(19) United States
(12) Patent Application Publication
(10) Pub. No.: US 2005/0259534 A1
(43) Pub. Date: Nov. 24, 2005

(54) Changer type disc apparatus

(75) Inventor: Masahiro Hashimoto, Osaka (JP)

Correspondence Address: MORGAN LEWIS & BOCKIUS LLP, 1111 PENNSYLVANIA AVENUE NW, WASHINGTON, DC, 20004, US

(73) Assignee: FUNAI ELECTRIC CO., LTD.

(21) Appl. No.: 11/132,329

(22) Filed: May 19, 2005

(30) Foreign Application Priority Data
May 21, 2004 (JP) P2004-152249

(51) Int. Cl. G11B 5/09

(52) U.S. Cl. 369/47.1; 369/53.1

(57) ABSTRACT

A changer type disc apparatus having a disc changer portion, on which plural discs are mountable, a recording/playing portion for recording a video signal on a disc mounted on the disc changer portion and for playing the video signal recorded thereon, a tuner portion for outputting a video signal obtained by receiving a commercial broadcasting signal, and control means for recording the video signal outputted by the tuner portion, on a disc by using the recording/playing portion, further comprising classification information recording means for recording classification information, according to which programs received by the tuner portion are classified, on a disc by using the recording/playing portion. When a program is reservation-recorded, the control means records a video signal, which is outputted by the tuner portion, on a disc, on which classification information corresponding to the program to be reservation-recorded is recorded, among discs mounted on the disc changer portion.

### BACKGROUND OF THE INVENTION

1. Field of the Invention

The present invention relates to a changer type disc apparatus, which has a disc changer portion enabled to load plural discs therein and which records video signals outputted from a tuner portion for receiving commercial broadcasting signals.

2. Description of the Related Art

In a case where commercial broadcasting signals are received and recorded on DVDs, in view of arranging and storing DVDs, it is more desirable to record broadcasting programs, which belong to a same category, on a DVD associated with this category among DVDs respectively associated with different categories rather than recording of broadcasting programs, which respectively belong to different categories, on each single DVD. Further, a program to be broadcasted every week is recorded on a same DVD thereby to further facilitate the arrangement of DVDs. Thus, the following technique (hereunder referred to as a first conventional technique) has been proposed. That is, according to this technique, an acoustic apparatus is provided with a disc mounting portion enabled to mount five mini discs, that is, first to fifth mini discs. Furthermore, this apparatus is enabled to designate which of the first to fifth mini discs is used for recording the program, after data representing the day and time, at which a program to be recorded is broadcasted, and also representing a broadcasting station, from which the program is received, are inputted thereto. That is, the apparatus can designate which of the mini discs each of programs to be broadcasted every week is recorded on. Therefore, the apparatus can selectively record only a specific program, which is broadcasted on a specific day of the week, on an associated one of the mini discs (see, for instance, JP-A-11-306615). For example, only the program, the broadcasting of which is started at seven o'clock on Monday, is recorded on the first mini disc. Only the program, the broadcasting of which is started at eight o'clock on Tuesday, is recorded on the second mini disc.

Also, the following technique (hereunder referred to as a second conventional technique) has been proposed. That is, according to this technique, a recording apparatus has a disc changer enabled to load plural discs therein. Further, when a program is recorded on a disc, first, program related information showing the detail of the program is obtained from received commercial broadcasting signals and recorded on a detail information recording area of the disc. Further, upon completion of recording the program, management information representing the title, the recording time, and the recording position of the program is created. The created management information is recorded on a management information recording area of the disc. Furthermore, the management information and the program related information are read from each of all the discs loaded in the disc changer. The read management information and the read program related information are stored in a predetermined memory area provided in the apparatus. Also, when the display of information concerning the disc is designated, the management information and the program related information are read from the memory area and displayed (see, for instance, JP-A-2002-216427, Paragraphs Nos. 0025 to 0029).

However, in the case of using the first conventional technique, the following problem has arisen. That is, it is assumed that recording of programs on DVDs is reserved in such a way as to record programs, which belong to a same category, on the DVD, which is associated with this category, among the DVDs respectively associated with different categories. At that time, it is necessary to designate the disc used for recording the program, after data representing the day and time, at which the program to be recorded is broadcasted, and also representing a channel, on which the program is broadcasted, are inputted thereto. Therefore, the number of steps of an input procedure increases, so that the reservation of recording the program tends to be cumbersome. Also, it is necessary to store the corresponding relation between the DVDs and the categories. This makes the setting of the reservation of recording the programs more cumbersome. Furthermore, in the case of setting a method of designating a disc on which a program is recorded, as a method of designating such a disc in terms of the position thereof on a tray, when the disc is replaced with another disc after the reservation of recording the program is set, the following trouble is caused. That is, the program is recorded on the latter disc, which differs from the former disc assumed when the reservation of recording thereof is set (this trouble is not disclosed in detail in the JP-A-11-306615 and remains an unsolved problem).

The second conventional technique enables the apparatus to quickly display the management information and the program related information, which concern video signals recorded on the disc. Thus, from the viewpoint of solving the aforementioned problem, it is difficult to apply this technique to the apparatus.

### SUMMARY OF THE INVENTION

The invention is created to solve the aforementioned problem. Accordingly, an object of the invention is to provide a changer type disc apparatus enabled to record only programs of the same kind on the same disc even when the designation of a disc, on which a program is recorded, is omitted, in a case where the reservation of recording plural programs is performed and where the reservation of recording plural programs is performed, by recording classification information, which includes information representing categories and titles of programs and is used for classifying programs to record, on each of discs and by recording, when a program is reservation-recorded, the program on a disc, on which classification information corresponding to a program to be reservation-recorded is recorded, among discs mounted on the disc changer portion, and also enabled to make a disc, on which classification information is recorded, usable in an apparatus that does not use classification information.

Also, another object of the invention is to provide a changer type disc apparatus enabled to record only programs of the same kind on the same disc even when the designation of a disc, on which a program is recorded, is omitted, in a case where the reservation of recording plural programs is performed and where the reservation of recording plural programs is performed, by recording classification information, which includes information representing categories and titles of programs and is used for classifying programs to record, on each of discs and by recording, when a program is reservation-recorded, the program on a disc, on which classification information corresponding to a program to be reservation-recorded is recorded, among discs mounted on the disc changer portion.

Also, another object of the invention is to provide a changer type disc apparatus adapted to preliminarily record reservation information needed for reservation of recording on a disc and to perform reservation-recording on a disc, on which reservation information is recorded, according to the reservation information, which is recorded on the disc, thereby being enabled to automatically perform reservation-recording only by mounting a disc on a disc changer portion and also enabled to make a disc, on which the reservation information is recorded, usable in an apparatus that does not use reservation information.

Also, another object of the invention is to provide a changer type disc apparatus adapted to preliminarily record reservation information needed for reservation of recording on a disc and to perform reservation-recording on a disc, on which reservation information is recorded, according to the reservation information, which is recorded on the disc, thereby being enabled to automatically perform reservation-recording only by mounting a disc on a disc changer portion.

To solve the aforementioned problem, according to an aspect of the invention, there is provided a changer type disc apparatus having a disc changer portion, on which plural discs are mountable, a recording/playing portion for recording a video signal on a disc mounted on the disc changer portion and for playing the video signal recorded thereon, a tuner portion for outputting a video signal obtained by receiving a commercial broadcasting signal, and control means for recording the video signal, which is outputted by the tuner portion, on a disc by using the recording/playing portion. This disc apparatus further includes classification information recording means for recording classification information, according to which programs received by the tuner portion are classified, on a disc by using the recording/playing portion. This disc apparatus features that when a program is reservation-recorded, the control means records a video signal, which is outputted by the tuner portion, on a disc, on which classification information corresponding to the program to be reservation-recorded, among discs mounted on the disc changer portion, and that the classification information recording means records classification information on a recording area, on which volume/file structure information is recorded in a VR format, in the form of a file.

That is, only programs classified according to classification information are recorded on a disc on which the classification information is recorded. Thus, for example, in a case where a disc, on which classification information designating the category of a spot program is recorded, and a disc on which classification information designating the category of a drama program are mounted, when a program to be reservation-recorded is a sport program, the disc, on which the classification information designating the category of a sport program is recorded, is selected and the recording of a program is performed thereon. When a program to be reservation-recorded is a drama program, the disc, on which the classification information designating the category of a drama program is recorded, is selected and the recording of a program is performed thereon. Further, data in the form of a file, which is stored in a recording area for storing volume/file structure in formation in a VR format, is not deleted in an apparatus that does not use classification information. Also, when data is recorded on the data area, the classification information is not deleted. And, the recording of data on the data area is not obstructed.

Also, according to another aspect of the invention, there is provided a changer type disc apparatus having a disc changer portion, on which plural discs are mountable, a recording/playing portion for recording a video signal on a disc mounted on the disc changer portion and for playing the video signal recorded thereon, a tuner portion for outputting a video signal obtained by receiving a commercial broadcasting signal, and control means for recording the video signal, which is outputted by the tuner portion, on a disc by using the recording/playing portion. This disc apparatus further includes classification information recording means for recording classification information, according to which programs received by the tuner portion are classified, on a disc by using the recording/playing portion. This disc apparatus features that when a program is reservation-recorded, the control means records a video signal, which is outputted by the tuner portion, on a disc, on which classification information corresponding to the program to be reservation-recorded, among discs mounted on the disc changer portion.

That is, only programs classified according to classification information are recorded on a disc on which the classification information is recorded. Thus, for example, in a case where a disc, on which classification information designating the category of a spot program is recorded, and a disc on which classification information designating the category of a drama program are mounted, when a program to be reservation-recorded is a sport program, the disc, on which the classification information designating the category of a sport program is recorded, is selected and the recording of a program is performed thereon. When a program to be reservation-recorded is a drama program, the disc, on which the classification information designating the category of a drama program is recorded, is selected and the recording of a program is performed thereon.

Also, according to another aspect of the invention, there is provided a changer type disc apparatus having a disc changer portion, on which plural discs are mountable, a recording/playing portion for recording a video signal on a disc mounted on the disc changer portion and for playing the video signal recorded thereon, a tuner portion for outputting a video signal obtained by receiving a commercial broadcasting signal, and control means for recording the video signal, which is outputted by the tuner portion, on a disc by using the recording/playing portion. This disc apparatus further includes reservation information recording means for recording reservation information, which includes information representing a day of week, a recording start time, and a channel and is needed for setting of reservation-recording, on a disc by using the recording/playing portion. This disc apparatus features that when reservation information is recorded on a disc mounted on the disc changer portion, the control means performs reservation-recording according to the reservation information recorded on the disc on which the reservation information is recorded and which a video signal is recorded, and that the reservation information recording means records reservation information on a recording area, on which volume/file structure information is recorded in a VR format, in the form of a file.

That is, reservation-recording is performed on a disc, on which reservation information is recorded, according to the recorded reservation information only by mounting the disc, on which the reservation information is recorded, on the disc changer portion. Further, data in the form of a file, which is stored in a recording area for storing volume/file structure information in a VR format, is not deleted in an apparatus that does not use classification information. Also, when data is recorded on the data area, the classification information is not deleted. And, the recording of data on the data area is not obstructed.

Also, according to another aspect of the invention, there is provided a changer type disc apparatus having a disc changer portion, on which plural discs are mountable, a recording/playing portion for recording a video signal on a disc mounted on the disc changer portion and for playing the video signal recorded thereon, a tuner portion for outputting a video signal obtained by receiving a commercial broadcasting signal, and control means for recording the video signal, which is outputted by the tuner portion, on a disc by using the recording/playing portion. This disc apparatus further includes reservation information recording means for recording reservation information, which includes information representing a day of week, a recording start time, and a channel and is needed for setting of reservation-recording, on a disc by using the recording/playing portion. This disc apparatus features that when reservation information is recorded on a disc mounted on the disc changer portion, the control means performs reservation-recording according to the reservation information recorded on the disc on which the reservation information is recorded and which a video signal is recorded.

That is, the reservation-recording is performed on a disc, on which reservation information is recorded, according to the recorded reservation information only by mounting the disc, on which the reservation information is recorded, on the disc changer portion.

According to the invention, only programs classified according to classification information are recorded on a disc on which the classification information is recorded. Further, data in the form of a file, which is stored in a recording area for storing volume/file structure information in a VR format, is not deleted in an apparatus that does not use classification information. Also, when data is recorded on the data area, is the classification information is not deleted. And, the recording of data on the data area is not obstructed, Thus, in a case where the recording of plural programs is reserved, even when the designation of a disc, on which a program is recorded, is omitted, only programs of the same kind can be recorded on the same disc. Also, a disc, on which classification information is recorded, can be used even in an apparatus that does not use classification information.

Further, according to the invention, only programs classified according to classification information are recorded on a disc on which the classification information is recorded. Thus, in a case where the recording of plural programs is reserved, even when the designation of a disc, on which a program is recorded, is omitted, only programs of the same kind can be recorded on the same disc.

Furthermore, according to the invention, reservation-recording according to reservation information, which is recorded on a disc, is performed on the disc, on which the reservation information is recorded, only by mounting the disc, on which the reservation information is recorded, on the disc changer portion. Further, data in the form of a file, which is stored in a recording area for storing volume/file structure information in a VR format, is not deleted in an apparatus that does not use reservation information. Also, when data is recorded on the data area, the reservation is information is not deleted. And, the recording of data on the data area is not obstructed by the reservation information. Thus, the reservation-recording can be automatically performed only by mounting the disc on the disc changer portion. Therefore, the invention also has an advantage that an occurrence of an erroneous input can be prevented when information on reservation of recording is inputted. Additionally, a disc, on which reservation information is recorded, can be used in an apparatus that does not use reservation information.

Further, according to the invention, reservation-recording according to reservation information, which is recorded on a disc, is performed on the disc, on which the reservation information is recorded, only by mounting the disc, on which the reservation information is recorded, on the disc changer portion. Thus, the reservation-recording can be automatically performed only by mounting the disc on the disc changer portion. Therefore, the invention also has an advantage that an occurrence of an erroneous input can be prevented when information on reservation of recording is inputted.

### BRIEF DESCRIPTION OF THE DRAWINGS

FIG. 1 is a block diagram illustrating the electrical configuration of a first embodiment of a changer type disc apparatus according to the invention;

FIG. 2 is an explanatory diagram illustrating a recording is area, in which information is recorded in a VR format, on a DVD;

FIG. 3 is a flowchart illustrating a major operation of the first embodiment, which is performed when classification information is recorded on a DVD;

FIG. 4 is a flowchart illustrating a major operation of the first embodiment, which is performed when a program is reservation-recorded;

FIG. 5 is a block diagram illustrating the electrical configuration of a second embodiment;

FIG. 6 is a flowchart illustrating a major operation of the second embodiment, which is performed when reservation information is recorded on a DVD; and

FIG. 7 is a flowchart illustrating a major operation of the second embodiment, which is performed when a program is reservation-recorded.

### DETAILED DESCRIPTION OF THE INVENTION

Hereinafter, embodiments of the invention are described with reference to the accompanying drawings.

### First Embodiment

Classification information to be recorded on a DVD in a first embodiment of the invention is described hereinbelow. The classification information is information used for classifying programs according to categories, such as a sport program, a drama program, a popular song program, or a news program, or information, such as that representing the titles of programs, used for identifying the programs. Incidentally, in the case of employing the classification information as information representing the categories, the classification information may be set in such a manner as to represent plural categories, for example, a news program and a sport program. Additionally, this classification information is adapted so that programs are classified according to the same classification format as that used in an EPG (Electric Program Guide), which is transmitted by being included in a commercial broadcasting signal and represents program contents. That is, the classification information includes a set of information pieces that can be made to respectively correspond one-to-one to information pieces represented by the EFG.

The classification information formed by the aforementioned method is recorded on a DVD and used for limiting the kinds of programs to be recorded on DVDs. That is, the apparatus is provided with the disc changer, so that when a program to be reservation-recorded is a sport program (or a baseball game program) in a case where the reservation-reserved program can be recorded on a given one of plural DVDs mounted on the disc changer portion, the DVD, on which the classification information representing the sport program (or the baseball game program) is recorded, is selected. Then, the program is recorded on the selected DVD. Alternatively, when the program to be reservation-recorded is a popular song program, the DVD, on which the classification information representing the popular song program (or the baseball game program) is recorded, is selected. Then, the program is recorded on the selected DVD.

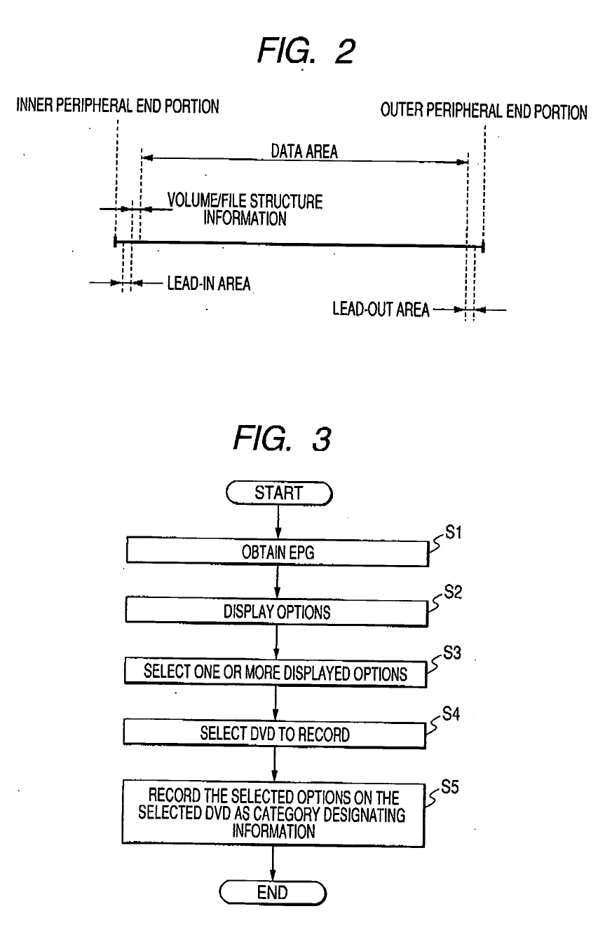

FIG. 2 is an explanatory diagram illustrating a recording area, on which information is recorded in a VR format, on a DVD.

As shown in this figure, a lead-in area is provided in the innermost peripheral portion of a DVD 11. An area, on which volume/file structure information is recorded, is provided in an outer peripheral portion that is in contact with the lead-in area. Further, in an outer peripheral portion of this area, a data area, on which a main part of information represented by the video signal is recorded, is provided. A lead-out area is provided in the outermost peripheral portion of the DVD 11.

Incidentally, the volume/file structure information represents what data is recorded on the data area and what hierarchical structure is employed so as to record such data thereon. Further, the aforementioned classification information is recorded in the form of a file on an area secured so as to record the volume/file structure information thereon. Thus, even when the classification information is recorded on the DVD 11, the information recorded on the DVD 11 satisfies the VR format. Moreover, even when data represented by the video signals is recorded within a given range in the data area, the classification information is prevented from being deleted.

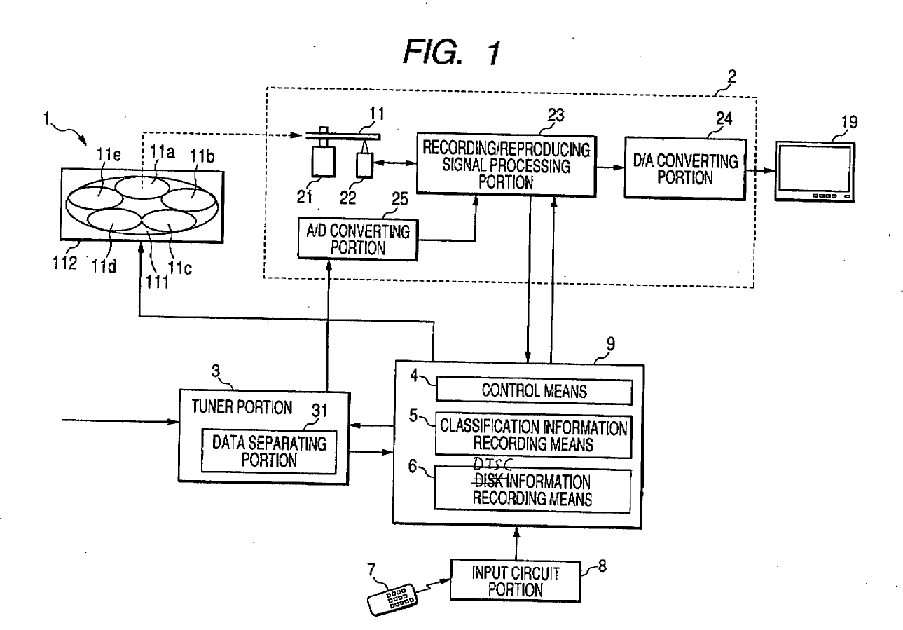

FIG. 1 is a block diagram illustrating the electrical configuration of a first embodiment of a changer type disc apparatus according to the invention. Concretely, this figure shows a changer type DVD recorder that has a rotary table onto which five discs are mountable, and that performs recording/playing of video signals by employing the VR format.

This embodiment roughly includes a disc changer portion 1, a recording/playing portion 2, a tuner portion 3, a remote controller 7, an input circuit portion 8, and a microcomputer 9. Main parts of a control means 4 and a classification information recording means 5 are constituted by software installed in the microcomputer 9. Also, a disc information memory 6 is constituted by a memory provided in the microcomputer 9. Moreover, the recording/playing portion 2 includes a spindle motor 21, a pickup 22, a recording/playing processing portion 23, a D/A converting portion 24, and an A/D converting portion 25.

Each block is described in detail hereinbelow. The tuner portion 3 receives commercial broadcasting signals broadcasted on a channel, which is designated by the control means 4, and outputs analog video signals (including analog audio signals), which are obtained by receiving the broadcasting signals, to the A/D converting portion 25. Incidentally, the commercial broadcasting signal received by the tuner portion 3 includes the EPG (Electric Program Guide), which is information representing the program contents (that is, information including information pieces representing the category and the title of the program). Thus, the tuner portion 3 uses a data separating portion 31 provided in the recorder thereby to separate the EPG from the received commercial broadcasting signal and to output the separated EPG to the control means 4. The A/D converting portion 25 converts analog video signals, which are outputted from the tuner portion 3, to digital video signals and outputs the digital video signals to the recording/playing signal processing portion 23. Further, the D/A converting portion 24 converts digital video signals, which are outputted from the recording/playing signal processing portion 23, to analog video signals (including analog audio signals) and outputs the analog video signals to a television receiver 19 provided outside the recorder.

The disc changer portion 1 is provided with a tray 112 having a rotary table 111 on which five DVDs (corresponding to the discs described in the appended claim) 11a to 11e are mountable. The disc changer portion 1 moves the DVD, which is put on a position designated by the control means 4, to a recording/playing position (that is, the position designated by reference character 11a). The spindle motor 21 clamps and rotation-drives the DVD (for example, the DVD 11a) moved to the recording/playing position among the DVDs 11a to 11e mounted on the rotary table 111. The pickup 22 reads a signal recorded on the DVD 11 rotation-driven by the spindle motor 21, and outputs the read signal to the recording/playing signal processing portion 23.

The recording/playing signal processing portion 23 performs predetermined processing on the signal outputted from the pickup 22 to thereby obtain digital data. Subsequently, the recording/playing signal processing portion 23 decodes the obtained digital data and thereafter performs an error correction to thereby demodulate a program stream. Then, a video stream of the program stream is decoded according to MPEG2 specification. Subsequently, the decoded video stream is outputted to the D/A converting portion 24. Moreover, an audio stream is decoded by a predetermined method. Then, the decoded audio stream is outputted to the D/A converting portion 24. Furthermore, a display signal indicating information on characters represented by a subpicture stream is generated and superimposed on the video signal.

Also, the recording/playing signal processing portion 23 performs compression on a digital video signal outputted from the A/D converting portion 25 according to the MPEG2 specification and subsequently encodes the compressed signal. Then, the recording/playing signal processing portion 23 outputs the signal for recording, which is obtained by the coding, to the pickup 22.

Also, the recording/playing signal processing portion 23 takes out volume/file structure information from the error-corrected stream and outputs the volume/file structure information to the control means 4. Also, in a case where the classification information is recorded on the DVD, the recording/playing signal processing portion 23 takes out the classification information therefrom and outputs the classification information to the control means 4.

The input circuit portion 8 has a key switch, such as a power key, provided on a front panel of a main unit (not shown) of the recorder and also has a light receiving unit for receiving infrared signals transmitted from the remote controller 7. When a user's operation is inputted, the input circuit portion 8 outputs a signal, which represents the operated key switch, to the control means 4.

The disc information memory 6 is provided with storage areas respectively associated with positions, on each of which a disc is mounted, on the rotary table 111 of the disc changer 1. The classification information recorded on each of the DVDs 11a to 11e mounted on the rotary table 111 is read from an associated one of the DVDs 11a to 11e and stored in the disc information memory 6.

The classification information recording means 5 displays a list of options, which can be selected by a user, in the television receiver 19 by referring to the EPG. Further, when a user selects a given option from the displayed list (the user can select plural options), information representing the selected option is written to the DVD 11 as the classification information. Incidentally, in the list of the selectable options, options representing categories, such as the sport program, the drama program, the popular song program, and the news program, are shown together with the titles of programs, as the selectable options.

The control means 4 controls a major operation in which the recorder serves as the changer type disc apparatus. That is, the DVD from which the signal is played, or the DVD on which the video signal is recorded, is moved to the recording/playing position by controlling the disc changer portion 1. Then, the video signal recorded on the DVD 11, which is moved to the recording/playing portion, is played and displayed in the television receiver 19 by controlling the recording/playing signal processing portion 23. Furthermore, a program associated with a channel designated by the user is recorded on the DVD 11 by controlling the tuner portion 3 and the recording/playing signal processing portion 23.

Further, when a program is reservation-recorded, the control means 4 obtains the program information of such a program by referring to the EPG. Then, the control means 4 collates the obtained program information with the classification information stored in the disc information memory 6 thereby to search for the DVD 11 on which the classification information corresponding to the program to be reservation-recorded is recorded Thus, the video signal outputted by the tuner portion 3 is recorded on the found DVD 11.

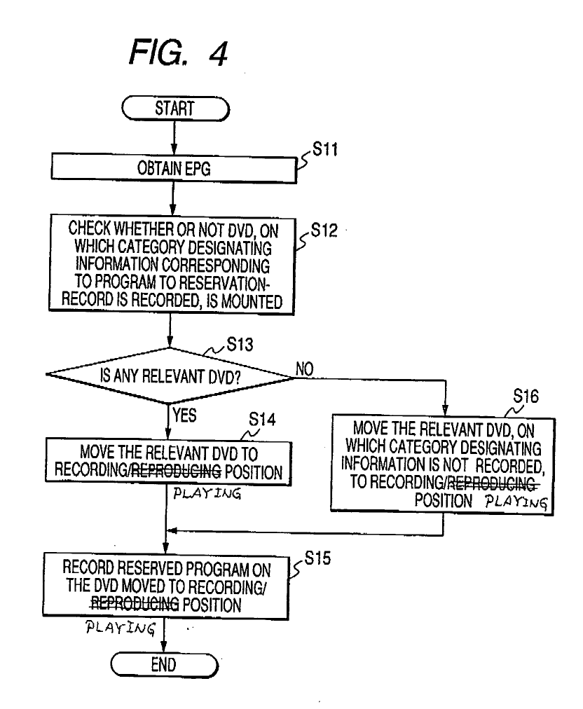

FIG. 3 is a flowchart illustrating a major operation of the first embodiment, which is performed when the classification information is recorded on the DVD. FIG. 4 is a flowchart illustrating a major operation of the first embodiment, which is performed when a program is reservation-recorded. An operation of the first embodiment is described hereinbelow by referring to these figures when needed.

When the recorder is put into a mode in which the classification information is recorded on the DVD, the classification information recording means 5 controls an operation of the tuner portion 3 and receives a commercial broadcasting signal to thereby obtain an EPG (step S1). Then, only the options, which are set to be selectable, are taken out of the obtained EPG as the classification information, and displayed in the television receiver 19. Incidentally, the options taken out at that time are the option designating the categories, such as the sport program, the news program, the drama program, and the popular song program, and the option representing the title of the program (step S2).

The user selects one of the options (or the plural options) as the information for specifying the program to record, from the categories and the titles of the programs displayed in the television receiver 19 (step S3). Subsequently, the user designates the DVD on which the classification information representing the selected options is recorded, among the five DVDs 11a to 11e mounted on the disc changer portion 1 (step S4). Upon completion of selecting the options and designating the DVD, the classification information recording means 5 controls the DVD in such away as to move to the recording/playing position. Thereafter, the classification information recording means 5 records the classification information as data in the form of a file on an empty one of the areas on which the volume/file structure information is recorded (step S5).

It is now assumed that as a result of the operation of the classification information recording means 5, the classification information representing the title “ABC” of the program, the classification information representing the category of the “drama program”, the classification information representing the category of the “sport program”, and the classification information representing the category of the “popular song program” are recorded on the DVDs 11a, 11b, 11c, 11d, and 11e, respectively, and that no classification information is recorded on the DVD 11e.

When the DVDs 11a to 11e are mounted on the disc changer portion 1, the control means 4 preliminarily reads the classification information recorded on each of the DVDs 11a to 11e and stores the read classification information in the disc information memory 6. Also, it is assumed that four programs are reservation-recorded, and that information representing a day of the week, a recording start time, a recording finish time, and a receiving channel, which is associated with each of the programs to be reservation-recorded, is inputted to the recorder (incidentally, the designation of the DVD, on which each of such programs is recorded, is unnecessary).

After the aforementioned operation is finished, an EPG is obtained by operating the tuner portion 3 a predetermined time (for instance, 1 minute) before the reservation-recording start time (step S11). Subsequently, the information representing the titles of the programs, which are to be reservation-recorded, and the categories, to which such programs respectively belong, is obtained by referring to the EPG. Then, it is checked according to the information stored in the disc information memory 6 whether or not it there any PVD on which the classification information corresponding to the obtained information representing the title of each of the programs is recorded (step S12).

Further, in a case where there is no DVD, on which the classification information representing the relevant title of the program is recorded, it is checked whether or not there is any DVD, on which the classification information representing the relevant category of the program to be reservation-recorded is recorded. That is, when it is checked whether or not there is any DVD, on which the relevant classification information is recorded, the checking according to the title of the program is preferentially performed. Furthermore, in the case where there is no DVD, on which the classification information representing the relevant title of the program is recorded, it is then checked whether or not there is any DVD, on which the classification information representing the relevant category is recorded.

It is now assumed that the category and the title of the program to be reservation-recorded are the “drama program” and the “ABC”, respectively. Then, the control means 4 moves the DVD 11a, on which information representing the title “ABC” of the program is recorded as the classification information, to the recording/playing position by controlling an operation of the disc changer portion 1 (steps S13 and S14). Subsequently, at the reservation-recording start time, the reserved program (that is, the program whose title is “ABC”) is recorded on the DVD 11a (step S15).

Alternatively, it is now assumed that the category of the program to be reservation-recorded is the “drama program” and that the title thereof is not “ABC”. The control means 4 moves the DVD 11b, on which information representing the category “drama program” is recorded as the classification information, to the recording/playing position (steps S12 to S14).

Subsequently, the reserved program is recorded on the DVD 11b (step S15). Further, in a case where the category of the program to be next reservation-recorded is assumed to be the “sport program”, such a reserved program is recorded on the DVD 11c at that time. Furthermore, in a case where the category of the program to be next reservation-recorded is assumed to be the “news program”, there is no DVD, on which the relevant classification information is recorded. Thus, the control means 4 records the reserved program on the DVD 11e on which no classification information is recorded.

Incidentally, for example, in a case where information representing the “news program” and the sport program” as the categories is recorded as the classification information on the DVD 11a, a program, whose category is the “news program”, and a program, whose category is the “sport program”, are reservation-recorded on the DVD 11a.

Further, although it has been described that the options obtained from the EPG are used as those to be used as the classification information displayed for a user's selection, a group of options preliminarily set by a user may be employed as the options for the displayed classification information (information representing the title of a program may be included in the options). Furthermore, in the case of employing this constitution, when information concerning the reservation-recording is inputted, an option is selected from a list of options respectively represented by information pieces which, can be selected as the classification information. The selected option is stored by being made to correspond to reservation-recording information. Besides, the control means 4 is configured in such a way as to control the recording/playing signal processing portion so that when a program is reservation-recorded, the program to be reservation-recorded is recorded on the DVD on which classification information corresponding to the classification option stored in such a way as to be associated with the reservation-recording information is recorded.

### Second Embodiment

Reservation information recorded on a DVD in a second embodiment of the invention is described hereinbelow. The reservation information is needed when a commercial broadcasting program is reservation-reserved. That is, the reservation information includes information pieces respectively representing a day of the week, a receiving channel, a recording start time, a recording finish time, and a bit rate at the recording. Further, the reservation information is recorded on an empty area, which is secured for recording volume/file structure information, in the form of a file.

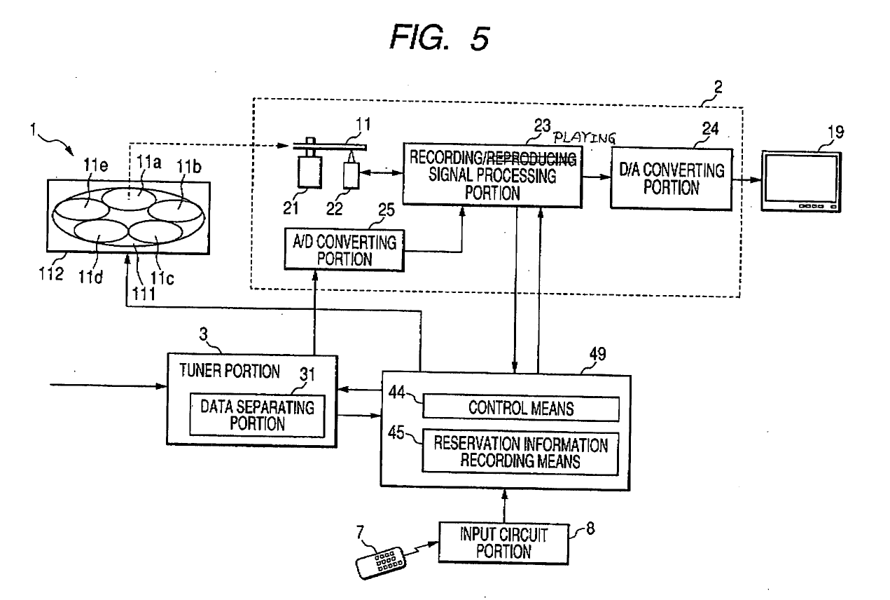

FIG. 5 is a block diagram illustrating the electrical configuration of a second embodiment of the changer type disc apparatus according to the invention. Concretely, this figure shows a changer type DVD recorder that has a rotary table onto which five discs are mountable, and that performs recording/playing of video signals by employing the VR format. Incidentally, blocks, which are the same as constituents shown in FIG. 1, are designated by the same reference characters as those designating such constituents shown in FIG. 1. Thus, the description of such constituents is omitted herein.

The reservation information recording means 45 is inputted by a user. Information needed for performing reservation-recording is recorded as the reservation information on a DVD designated by the user. That is, the reservation information including the information pieces, which respectively represent a day of the week, a receiving channel, a recording start time, a recording finish time, and a bit rate at the recording, is created as data in the form of a file. Further, the created reservation information in the form of a file is recorded on a DVD designated by a user.

The control means 44 controls a major operation in which the recorder serves as the changer type disc apparatus. That is, the DVD from which the signal is played, or the DVD on which the video signal is recorded, is moved to the recording/playing position by controlling the disc changer portion 1. Then, the video signal recorded on the DVD 11, which is moved to the recording/playing portion, is played and displayed in the television receiver 19 by controlling the recording/playing signal processing portion 23. Furthermore, a program associated with a channel designated by the user is recorded on the DVD 11 by controlling the tuner portion 3 and the recording/playing signal processing portion 23.

Additionally, in a case where the DVD, on which the reservation information is recorded, is mounted on the disc changer portion 1, when a program is reservation-recorded according to this reservation information, the control means 44 performs a control operation for recording the program, which is designated by the reservation information, on a DVD, on which the reservation information is recorded, at a bit rate represented by the reservation information.

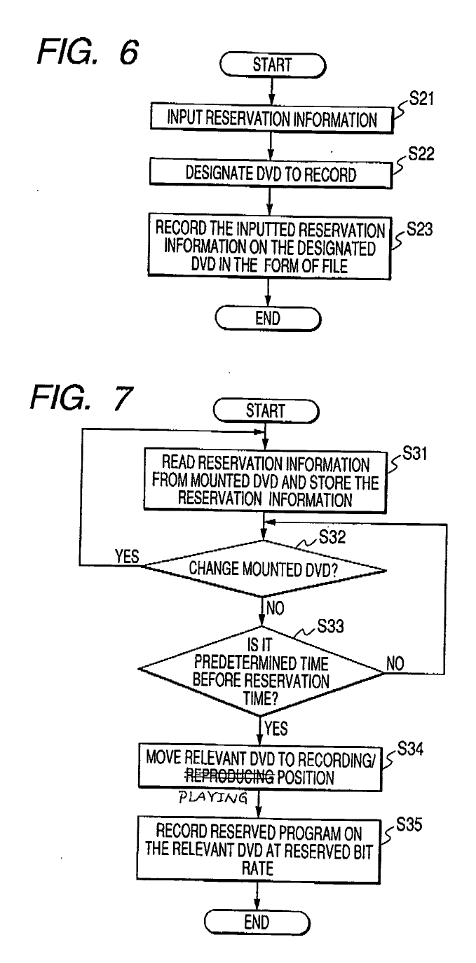

FIG. 6 is a flowchart illustrating a major operation of the second embodiment, which is performed when the reservation information is recorded on a DVD. FIG. 7 is a flowchart illustrating a major operation of the second embodiment, which is performed when a program is reservation-recorded. An operation of the second embodiment is described hereinbelow by referring to these figures when needed.

When the recorder is put in to a mode in which the reservation information is recorded on the DVD, the reservation information recording means 45 displays a screen for inputting data representing a day of the week, a recording start time, a recording finish time, and a bit rate at the recording. A user inputs the values of such data according to this display (step S21). Subsequently, the user designates the DVD on which the inputted reservation information is recorded (step S22). Then, the reservation information recording means 45 moves the designated DVD to the recording/playing position, and records the inputted reservation information on the designated DVD in the form of a file (step S23).

It is now assumed that the DVD, on which the reservation information is recorded, is mounted on the disc changer portion 1. That is, reservation information pieces differing from one another in data, which is represented by each of the information pieces, are recorded on the DVDs 11a to 11e, respectively. When the DVDs are mounted on the disc changer portion 1, the control means 44 reads the reservation information from each of the DVDs 11a to 11e mounted thereon, and stores the read information therein (step S31). Subsequently, operations in a loop consisting of steps S32 and S33 are performed.

That is, the control means 44 checks whether or not the DVDs 11a to 11e are taken out from or changed in the disc changer portion 1 (when a mounting portion provided therein is empty, it is also checked whether or not a new DVD is mounted therein). Further, when the mounted DVDs 11a to 11e are changed (that is, the replacement, the demounting, and the new mounting of the DVD occurs), the reservation information of the changed DVD is read. The reservation information stored in this embodiment is updated with the read reservation information (step S32 (when the DVD is demounted, the reservation information piece associated with the demounted DVD, among the reservation information pieces stored in the embodiment, is deleted)).

Moreover, the control means 44 checks whether or not a current day of the week corresponds to one of days of the week, which are designated by the reservation information pieces stored therein, and whether or not a current time is matched with the predetermined time (for instance, 1 minute) before the recording start time. For example, it is now assumed that the day of the week and the recording start time, which are designated by the reservation information recorded on the DVD 11c, is Monday and 21:00, respectively, and that the current day of the week and the current time is Monday and 20;59, respectively. Then, the control means 44 causes the operation to proceed to step S34 from step S33 to thereby move the DVD 11c to the recording/playing position (step S34). Subsequently, at 21:00, the control means 44 starts an operation of recording the program, which is broadcasted on the channel designated by the reservation information recorded on the DVD 11c, at the bit rate, which is designated by this reservation information, on the DVD 11c.

Further, it is assumed that the day of the week and the recording start time, which are designated by the reservation information recorded on the DVD 11d, is Tuesday and 20:00, respectively. At 20:00 on Tuesday, the control means 44 performs a control operation of recording the program, which is broadcasted on the channel designated by the reservation information, at a bit rate, which is also designated by the reservation information, on the DVD 11d.

Incidentally, the invention is not limited to the aforementioned embodiments. Although the case, in which the disc changer portion is configured so that five discs are mountable thereon, has been described, the invention can be also applied to another case where the number of mountable discs is other than 5 and is, for example, 4 or 25.

Further, the invention can be also applied to a case where the tuner portion 3 is configured in such a way as to receive a digital broadcasting signal.

1. A changer type disc apparatus having:
a disc changer portion, on which a plurality of discs are mountable;
a recording/playing portion for recording a video signal on a disc mounted on the disc changer portion and for playing the video signal recorded thereon;
a tuner portion for outputting a video signal obtained by receiving a commercial broadcasting signal; and
control means for recording the video signal, which is outputted by the tuner portion, on a disc by using the recording/playing portion, the changer type disc apparatus comprising:
classification information recording means for recording classification information, according to which programs received by the tuner portion are classified, on a disc by using the recording/playing portion, wherein
when a program is reservation-recorded, the control means records a video signal, which is outputted by the tuner portion, on a disc, on which classification information corresponding to the program to be reservation-recorded is recorded, among discs mounted on the disc changer portion, and
the classification information recording means records the classification information on a recording area, on which volume/file structure information is recorded, in a form of a file.

2. A changer type disc apparatus having:
a disc changer portion, on which a plurality of discs are mountable;
a recording/playing portion for recording a video signal on a disc mounted on the disc changer portion and for playing the video signal recorded thereon;
a tuner portion for outputting a video signal obtained by receiving a commercial broadcasting signal; and
control means for recording the video signal, which is outputted by the tuner portion, on a disc by using the recording/playing portion, the changer type disc apparatus further comprising:
classification information recording means for recording classification information, according to which programs received by the tuner portion are classified, on a disc by using the recording/playing portion, wherein,
when a program is reservation-recorded, the control means records a video signal, which is outputted by the tuner portion, on a disc, on which classification information corresponding to the program to be reservation-recorded is recorded, among discs mounted on the disc changer portion.

3. A changer type disc apparatus having:
a disc changer portion, on which a plurality of discs are mountable;
a recording/playing portion for recording a video signal on a disc mounted on the disc changer portion and for playing the video signal recorded thereon;
a tuner portion for outputting a video signal obtained by receiving a commercial broadcasting signal; and
control means for recording the video signal, which is outputted by the tuner portion, on a disc by using the recording/playing portion, the changer type disc apparatus further comprising:
reservation information recording means for recording reservation information, which includes information representing a day of week, a recording start time, and a channel and is needed for setting of reservation-recording, on a disc by using the recording/playing portion, wherein
when reservation information is recorded on a disc mounted on the disc changer portion, the control means performs reservation-recording according to the reservation information recorded on the disc on which the reservation information is recorded and which a video signal is recorded, and
the reservation information recording means records the reservation information on a recording area, on which volume/file structure information is recorded, in a form of a file.

4. A changer type disc apparatus having:
a disc changer portion, on which a plurality of discs are mountable;
a recording/playing portion for recording a video signal on a disc mounted on the disc changer portion and for playing the video signal recorded thereon;
a tuner portion for outputting a video signal obtained by receiving a commercial broadcasting signal; and
control means for recording the video signal, which is outputted by the tuner portion, on a disc by using the recording/playing portion, the changer type disc apparatus further comprising:
reservation information recording means for recording reservation information, which includes information representing a day of week, a recording start time, and a channel and is needed for setting of reservation-recording, on a disc by using the recording/playing portion, wherein
when reservation information is recorded on a disc mounted on the disc changer portion, the control means performs reservation-recording according to the reservation information recorded on the disc on which the reservation information is recorded and which a video signal is recorded.
